(19) United States
(12) Patent Application Publication
(10) Pub. No.: US 2026/0072672 A1
(43) Pub. Date: Mar. 12, 2026

(54) CONTROLLED ROLLOUT OF SOFTWARE FEATURES AND FUNCTIONS

(71) Applicant: Truist Bank, Charlotte, NC (US)

(72) Inventors: Glenn Pinto, Charlotte, NC (US); Sanjeev Gharmode, Charlotte, NC (US)

(73) Assignee: Truist Bank, Charlotte, NC (US)

(21) Appl. No.: 18/882,178

(22) Filed: Sep. 11, 2024

(51) Int. Cl. G06F 8/65

(52) U.S. Cl. CPC G06F 8/65

(57) ABSTRACT

Systems, apparatuses, and computer-implemented methods provide for technology that identifies a flag associated with a software feature in response to a retrieval request received via an application programming interface (API), wherein the software feature is shared by a plurality of web applications, and wherein the plurality of web applications are associated with a plurality of users, conducts an update to the flag in response to an update request received via the API, wherein the update prevents a first subset of the plurality of users from accessing the software feature, and wherein the update permits a second subset of the plurality of users to access the software feature, and bypasses a redeployment of the plurality of web applications during the update.

### TECHNICAL FIELD

Embodiments generally relate to the deployment of software updates. More particularly, embodiments relate to the controlled rollout of software features and functions.

### BACKGROUND

When new a feature and/or function (e.g., software update) is added to a web application, several technical challenges are often encountered. For example, implementing the update typically involves redeploying the entire web application. Additionally, if the new feature/function spans multiple web applications, the redeployment may be conducted for each web application, wherein the relevant code is maintained in the configuration of each web application. Indeed, because the new feature/function is typically either accessible or inaccessible to all users (e.g., 100 k users) of the web applications, if a problem (e.g., bug) is discovered in the update, conventional solutions often conduct a rollback to an earlier version of each web application for all users. These challenges can be time consuming, costly, and susceptible to error.

### SUMMARY

In one embodiment, a performance-enhanced computing system comprises a network controller, a processor coupled to the network controller, and a memory coupled to the processor, the memory including a plurality of instructions, which when executed by the processor, cause the processor to identify a flag associated with a software feature in response to a retrieval request received via an application programming interface (API), wherein the software feature is shared by a plurality of web applications, and wherein the plurality of web applications are associated with a plurality of users, conduct an update to the flag in response to an update request received via the API, wherein the update prevents a first subset of the plurality of users from accessing the software feature, and wherein the update permits a second subset of the plurality of users to access the software feature, and bypass a redeployment of the plurality of web applications during the update.

In another embodiment, at least one computer readable storage medium comprising a plurality of instructions, which when executed by a computing system, cause the computing system to identify a flag associated with a software feature in response to a retrieval request received via an application programming interface (API), wherein the software feature is shared by a plurality of web applications, and wherein the plurality of web applications are associated with a plurality of users, conduct an update to the flag in response to an update request received via the API, wherein the update prevents a first subset of the plurality of users from accessing the software feature, and wherein the update permits a second subset of the plurality of users to access the software feature, and bypass a redeployment of the plurality of web applications during the update.

In another embodiment, a semiconductor apparatus comprises one or more substrates and logic coupled to the one or more substrates, wherein the logic is implemented at least partly in one or more of configurable or fixed-functionality hardware, the logic to identify a flag associated with a software feature in response to a retrieval request received via an application programming interface (API), wherein the software feature is shared by a plurality of web applications, and wherein the plurality of web applications are associated with a plurality of users, conduct an update to the flag in response to an update request received via the API, wherein the update prevents a first subset of the plurality of users from accessing the software feature, and wherein the update permits a second subset of the plurality of users to access the software feature, and bypass a redeployment of the plurality of web applications during the update.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein;

FIG. 2 illustrates a block diagram of the mobile device of FIG. 1;

FIG. 3 illustrates a block diagram of the personal computing device of FIG. 1;

FIG. 4 illustrates a block diagram of the one or more financial institution servers of FIG. 1;

FIG. 5 is an illustration of an example of a software feature rollout architecture according to an embodiment;

FIG. 6 is a signaling diagram of an example of a feature flag management solution according to an embodiment;

FIG. 7A is an illustration of an example of a feature flag maintenance portion of a data model according to an embodiment;

FIG. 7B is an illustration of an example of an authentication portion of a data model according to an embodiment;

FIG. 7C is an illustration of an example of a metrics portion of a data model according to an embodiment;

FIGS. 8A and 8B are illustrations of an example of a feature flag update according to an embodiment;

FIG. 9 is an illustration of an example of metrics report according to an embodiment;

FIG. 10 is a flowchart of an example of a method of operating a performance-enhanced computing system according to an embodiment;

FIG. 11 is a block diagram of an example of a performance-enhanced computing system according to an embodiment; and

FIG. 12 is an illustration of an example of a semiconductor apparatus according to an embodiment.

### DETAILED DESCRIPTION

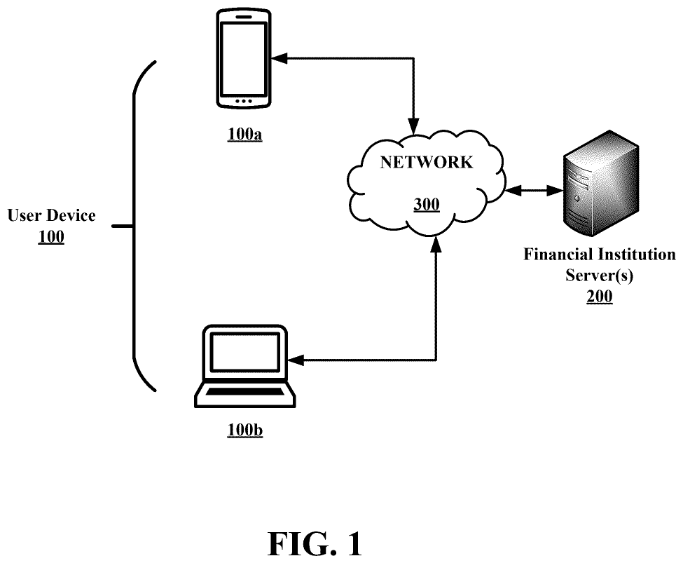

Turning to the figures, in which FIG. 1 illustrates a communication environment in which a user communicates with a financial institution. A user device 100 (100a, 100b) operating in the communication environment facilitates user access to and user management of one or more user accounts residing at one or more financial institution servers 200 of the financial institution. The communication environment includes the user device 100, the one or more financial institution servers 200, and a communications network 300 through which communication is facilitated between the user device 100 and the one or more financial institution servers 200.

In accordance with one or more embodiments, the user device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the user device 100 comprising any form of electronic device that optimizes the performance and functionality of the one or more embodiments in a manner that falls within the spirit and scope of the principles of this disclosure.

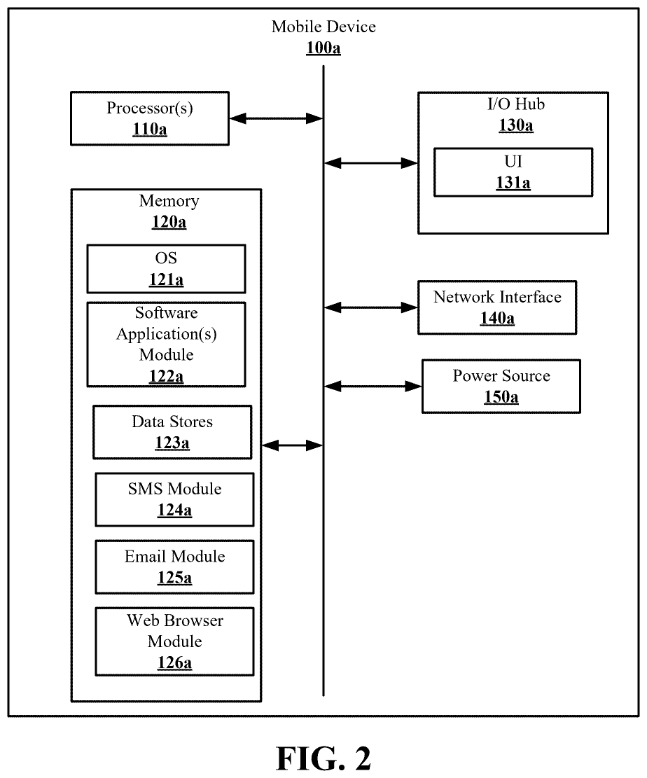

In the illustrated example embodiment of FIG. 2, the user device 100 (FIG. 1) comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause the one or more processors 110a to execute an operating system (OS) 121a and one or more software applications of a software application module 122a that reside in the memory 120a. The one or more software applications residing in the memory 120a includes, but is not limited to, a financial institution application that is associated with the financial institution servers 200 (FIG. 1) and which facilitates user access to the one or more user accounts in addition to user management of the one or more user accounts. The financial institution application comprises a mobile financial institution application that facilitates establishment of a secure connection between the mobile device 100a and the one or more financial institution servers 200 (FIG. 1).

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS (short messaging service) module 124a operable to facilitate user transmission and receipt of text messages via the mobile device 100a though the network 300 (FIG. 1). In one example embodiment, a user may receive text messages from the financial institution that are associated with the user access and the user management of the one or more user accounts. An email module 125a is operable to facilitate user transmission and receipt of email messages via the mobile device 100a through the network 300 (FIG. 1). In one example embodiment, a user may receive email messages from the financial institution that are associated with the user access and the user management of the one or more user accounts. A user may utilize a web browser module 126a that is operable to facilitate user access to one or more websites associated with the financial institution through the network 300 (FIG. 1).

In accordance with one or more embodiments, the mobile device 100a includes an I/O hub 130a operatively connected to other systems and subsystems of the mobile device 100a. The I/O hub 130a may include one or more of an input interface, an output interface, and a network controller to facilitate communications between the user device 100 and the server 200 (FIG. 1). The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes a power source 150a that comprises a wired powered source, a wireless power source, a replaceable battery source, or a rechargeable battery source.

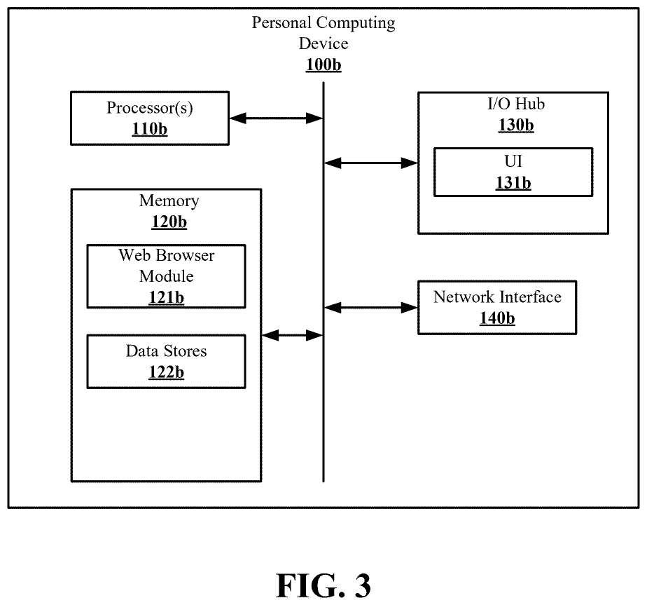

In the illustrated example embodiment of FIG. 3, the user device 100 (FIG. 1) comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110b, an I/O hub 130b, and a network interface 140b. The I/O hub 130b may include one or more of an input interface, an output interface, and a network controller to facilitate communications between the user device 100 and the server 200 (FIG. 2). The input interface and the output interface may be integrated as a single, unitary user interface 131b, or alternatively, be separate as independent interfaces that are operatively connected.

The memory 120b comprises a set of instructions of computer-executable program code. The set of instructions are executable by the one or more processors 110b to cause the one or more processors 110b to control the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122a may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a (FIGS. 2), 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a (FIGS. 2), 110b may comprise at least one hardware circuit (e.g., an integrated circuit) operable to carry out instructions contained in program code. In embodiments in which there is a plurality of processors, such processors may work independently from each other, or one or more processors may work in combination with each other.

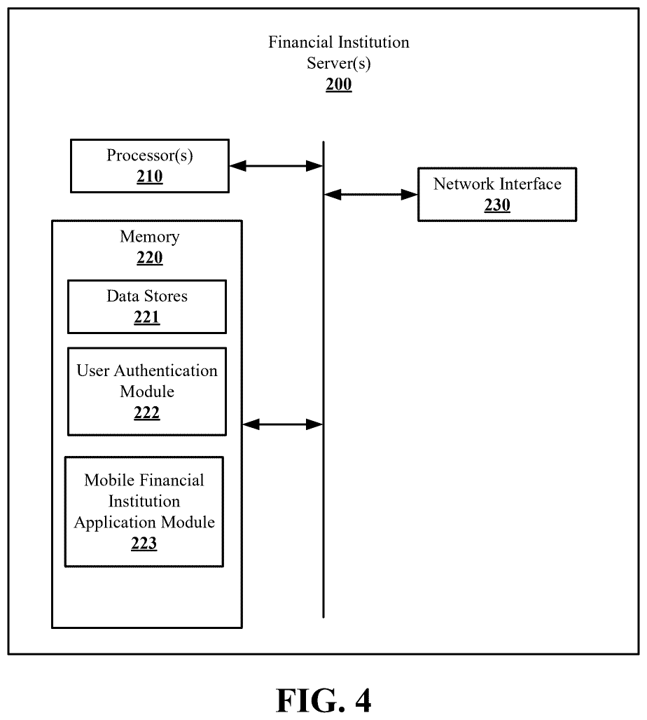

As illustrated in FIG. 4, the one or more financial institution servers 200 includes one or more processors 210, a non-transitory memory 220 operatively coupled to the one or more processors 210, and a network interface 230. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220.

The memory 220 also includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The computer-executable program code may instruct the one or more processors 210 to cause the user authentication module 222 to authenticate a user in order to gain user access to the one or more user accounts. The user authentication module 222 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile financial institution applications of the mobile financial institution application module 223 may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 223 are operable to communicate with the user device 100 (FIG. 1) in a manner which facilitates user access to the one or more user accounts in addition to user management of the one or more user accounts based on successful user authentication.

In accordance with one or more embodiments set forth, described, and/or illustrated herein, the network 300 (FIG. 1) may comprise a wireless network, a wired network, or any suitable combination thereof. For example, the network 300 (FIG. 1) is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

### Controlled Rollout of Software Features/Functions

As will be discussed in greater detail, the technology described herein targets specific users or sets of users to have controlled access to gradually enabled feature flags. Such an approach enables risk to be managed and feedback to be gathered for different user groups. Allowlisting (e.g., whitelisting) is used for specific customer segments, enabling precisely controlled feature availability based on start and expiry dates. This fine-grained control ensures that features are accessible only to the intended audience during designated time windows.

More particularly, the technology described herein includes an independent application (e.g., including both user interface/UI and application programming interface/API components) that manages feature flags using feature flag control and user, customer and/or agent allowlists. The independent application can be extensible to include other types of data elements relevant to the business, and flag durations can control permanent feature activation/deactivation. The UI enables management and organization of feature flag controls by lines of business (LOB), applications, and specific features. Meanwhile, the API delivers feature flag status information such as authorized users, customers, agents, the current status of the feature flag, and duration by feature flag control to consuming applications in real-time.

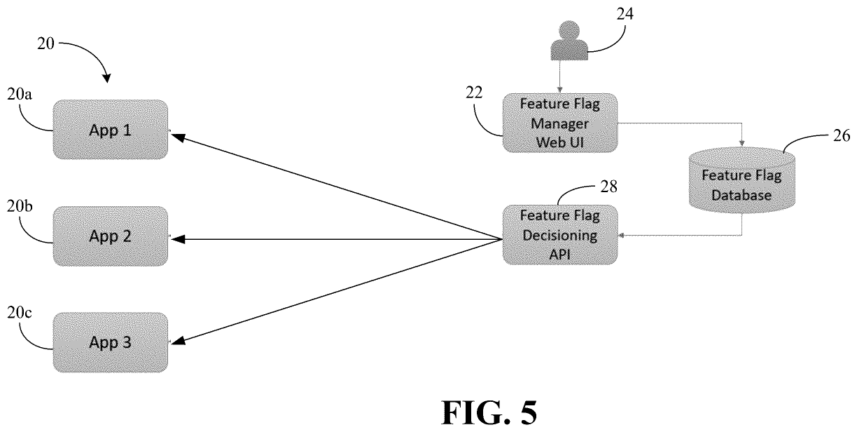

Turning now to FIG. 5, a software feature rollout architecture is shown for a plurality of applications 20 (20a-20c). For example, the applications 20 can be different (e.g., unrelated) web applications that are stored on a remote server and delivered over the Internet through a browser interface. Thus, a first application 20a (“App 1”) might perform and/or support a first set of services, a second application 20b (“App 2”) may perform and/or support a second set of services that are different from the first set of services, and a third application 20c (“App 3”) might perform and/or support a third set of services that are different from the first and second sets of services. The applications 20 may share, however, one or more software features and/or functions that are managed through feature flags. All applications 20 using a given feature flag can implement multiple feature flag controls.

In the illustrated example, a web user interface (UI) 22 enables a user 24 (e.g., business user) to set up and manage feature flag details for each feature flag control used by the applications 20. The feature flag control details may be stored in a database 26 (e.g., centralized source) that is external to the applications 20. Accordingly, the status and duration of features can be retrieved from the database 26 based on the type of feature flag control being requested, wherein the retrieved status/duration can be delivered to the applications 20 through a feature flag and decisioning API (application programming interface) 28. In an embodiment, the decisioning portion of the API 28 is separate from the feature flag management portion of the API 28, which is used by the web applications 20 to list out feature flags, create feature flags, update feature flags, turn on or off feature flags, etc. The code base/application of both portions of the API 28 can be the same and can host both the decisioning portion and the feature flag management portion.

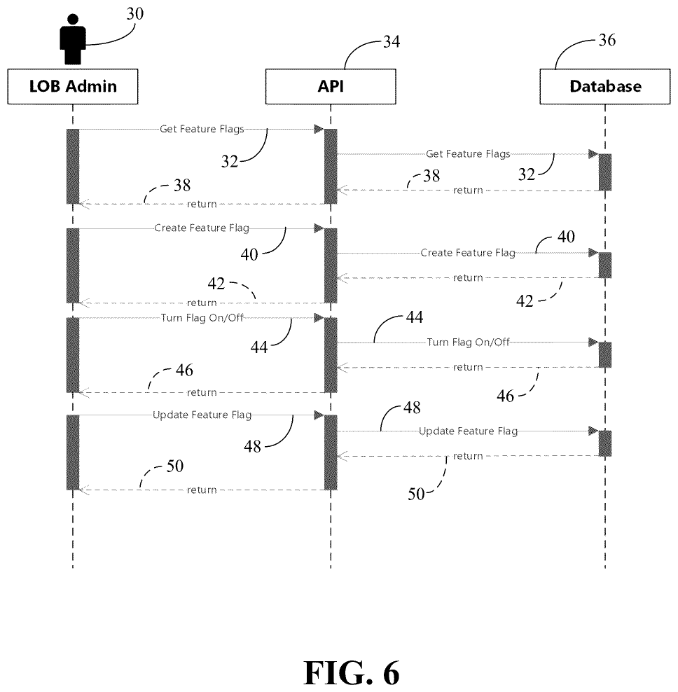

FIG. 6 shows a signaling diagram in which an administrator 30 (e.g., LOB admin) issues a retrieval request 32 (“Get Feature Flags” message) to an API 34, which forwards the retrieval request 32 to a database 36. The database 36 returns a retrieval response 38 that identifies the flags associated with the software features specified in the retrieval request 32. In the illustrated example, the API 34 forwards the retrieval response 38 to the administrator 30.

The administrator 30 may also issue a creation request 40 (“Create Feature Flag” message) to the API 34, which forwards the creation request 40 to the database 36. The database 36 returns a creation response 42 identifying the feature flag that has been created. The API 34 may return the creation response 42 to the administrator 30.

In one example, the administrator 30 issues an activation or deactivation request 44 (“Turn Flag On/Off” message) to the API 34, wherein the API 34 forwards the activation or deactivation request 44 to the database 36. The database 36 returns an activation or deactivation response 46 to the API 34 and the API 34 forwards the activation or deactivation response 46 to the administrator 30.

In another example, the administrator 30 issues an update request 48 (“Update Feature Flag” message) to the API 34, which forwards the update request 48 to the database 36. The database 36 returns an update response 50 to the API 34 confirming the update to the feature flag and the API 34 forwards the update response 50 to the administrator 30. The illustrated signaling diagram therefore demonstrates the seamless feature flag management solution achieved via the technology described herein.

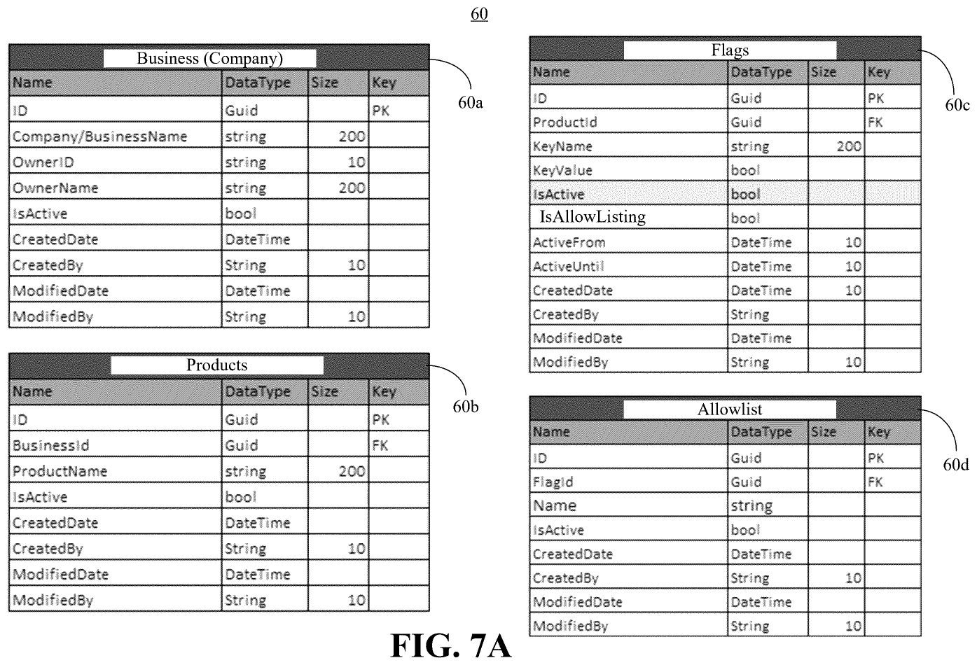

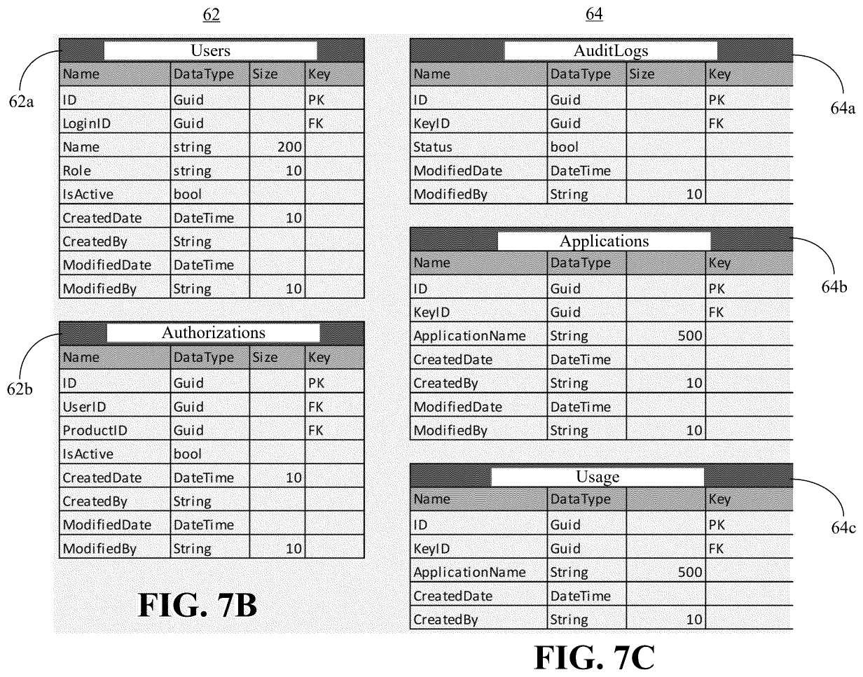

FIGS. 7A-7C show a data model having a feature flag maintenance portion 60 (60a-60d), an authentication (e.g., authorization) portion 62 (62a-62b), and a metrics portion 64 (64a-64c). The feature flag maintenance portion 60 defines the columns and attributes (e.g., data type, size, key) of a business (e.g., company) table 60a, a products table 60b, a flags table 60c and an allowlist (e.g., whitelist) table 60d. In combination, the business table 60a and the products table 60b provide for a hierarchical management structure in which each business unit can have multiple product lines and each product line can be associated with multiple feature flags. Additionally, the flags table 60c tracks feature flags on a per product basis and the allowlist table 60d enables feature access to be permitted or prevented on a per user basis. The authentication portion 62 defines the columns and attributes of a users table 62a and an authorizations table 62b. The metrics portion 64 defines the columns and attributes of an audit logs table 64a, an applications table 64b and a usage table 64c.

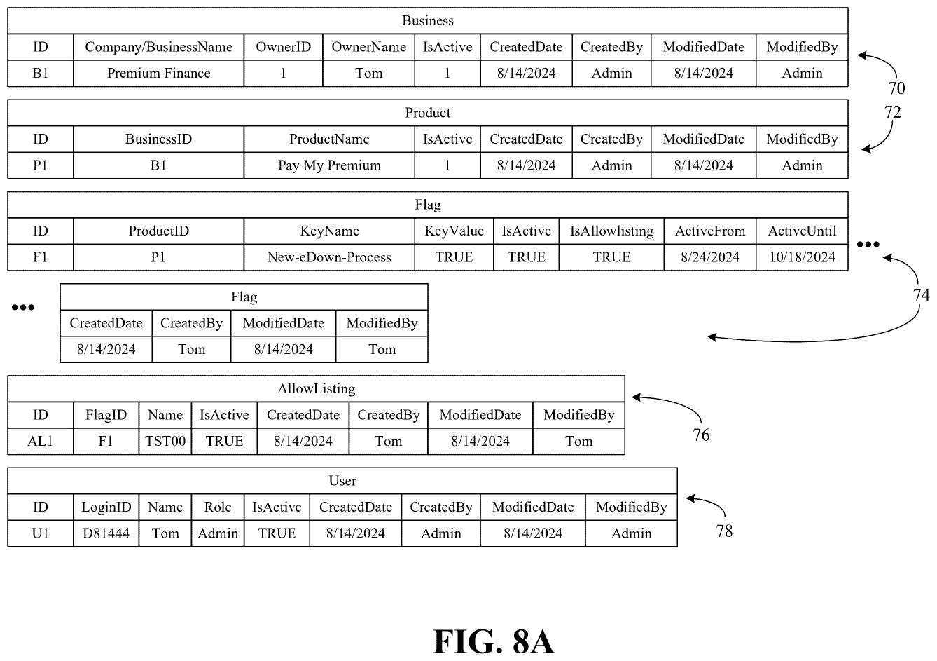

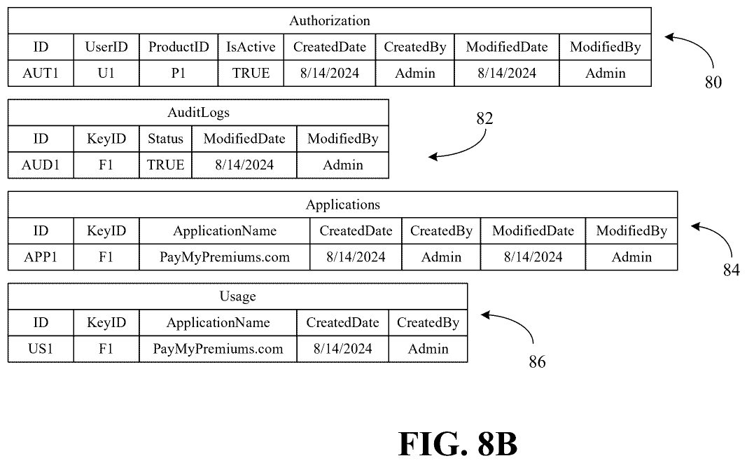

FIGS. 8A and 8B show an example of a feature flag update in which an administrator (“Admin”) designates an individual “Tom” (e.g., business user) as an owner of the “Premium Finance” business in a business table entry 70 and associates the product “Pay My premium” with the Premium Finance business in a product table entry 72. The owner Tom creates (e.g., via a web UI) a flag table entry 74 for the feature “New-eDown-Process” in the Pay My premium product, wherein the flag table entry 74 includes an activation date range (e.g., “ActiveFrom”, “ActiveUntil”) and indicates whether allowlisting is active for the feature. The owner Tom also creates an allowlisting table entry 76, which permits a user “TST00” to access the New-eDown-Process feature. Thus, the user TST00 will have access to the New-eDown-Process feature only during the activation date range in the flag table entry 74. Accordingly, if a problem/bug is encountered in the New-eDown-Process feature, access to that feature by the user TST00 can be withdrawn while the feature is being debugged by merely adjusting the activation date range in the flag table entry 74 or removing the allowlisting table entry 76. In one example, entries may be added to the allowlisting table automatically (e.g., in response to a loan balance falling below a given threshold).

Additionally, the Admin may create a user table entry 78 to designate the owner Tom as an administrator and an authorization table entry 80 that grants the owner Tom access to the Pay My premium product. Metrics such as an audit logs table entry 82, an applications table entry 84 and a usage table 86 can also be used to track the usage of the New-eDown-Process features on a per application basis.

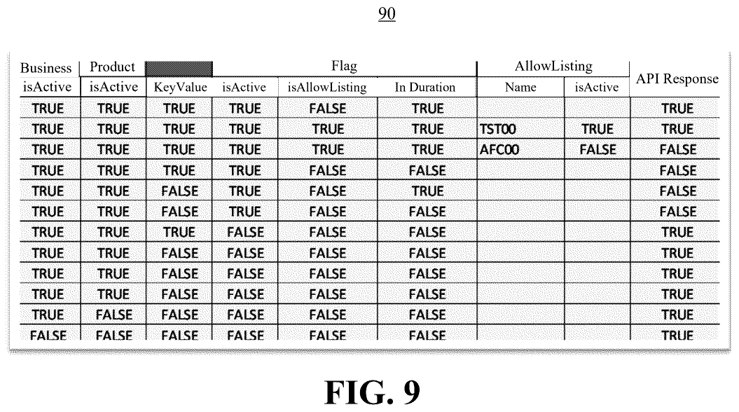

FIG. 9 shows a metrics report 90 in which allowlisting is enabled for the users TST00 and “AFC00”. For the given business, product and feature flag, however, the user TST00 is permitted to access the software feature and the user AFC00 is prevented from accessing the software feature.

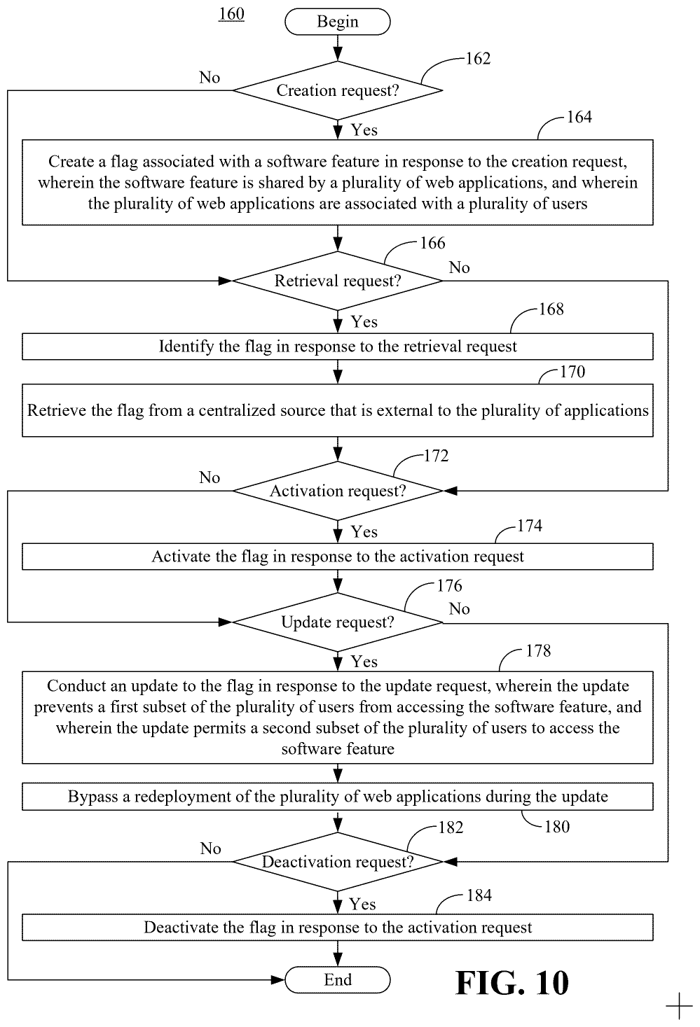

FIG. 10 shows a computer-implemented method 160 of operating a performance-enhanced computing system. The computer-implemented method 160 may generally be implemented in a server such as, for example, the financial institution server(s) 200 (FIGS. 1 and 4), already discussed. More particularly, the computer-implemented method 160 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the computer-implemented method 160 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 162 determines whether a creation request has been received via an API such as, for example, the API 28 (FIG. 5), already discussed. If so, block 164 creates a flag associated with a software feature in response to the creation request. In the illustrated example, the software feature is shared by a plurality of web applications and the plurality of web applications are associated with a plurality of users. If no creation request is detected at block 162, the method 160 bypasses block 164. Block 166 determines whether a retrieval request has been received via the API. If so, block 168 identifies the flag associated with the software feature in response to the retrieval request and block 170 retrieves the flag from a centralized source (e.g., feature flag database) that is external to the plurality of applications. Block 170 may also output the retrieved flag via the API. If no retrieval request is detected at block 166, the illustrated method 160 bypasses blocks 168 and 170.

Block 172 determines whether an activation request has been received via the API. If so, block 174 activated the flag in response to the activation request. If no activation request is detected at block 172, the illustrated method 160 bypasses block 174. Block 176 determines whether an update request has been received via the API. The update may also be triggered automatically in response to a condition being detected such as, for example, the loan balance of a user falling below or exceeding a given threshold. If the update request is detected, block 178 conducts an update to the flag in response to the update request. In the illustrated example, the update prevents a first subset of the plurality of users from accessing the software feature and permits a second subset of the plurality of users to access the software feature. In an embodiment, block 178 includes modifying an allowlist (e.g., whitelist) associated with the flag. Block 178 may also modify an activation date range associated with the flag. Additionally, block 180 bypasses a redeployment of the plurality of web applications during the update. If no update request is detected at block 176, the illustrated method 160 bypasses blocks 178 and 180. Block 182 provides for determining whether a deactivation request has been received via the API. If so, block 184 deactivates the flag in response to the activation request. Otherwise, the illustrated method 160 bypasses block 184 and terminates.

The method 160 therefore enhances performance at least to the extent that selectively granting access to software features on a per user (e.g., customer, agent) basis via the flag updates provides greater flexibility, extensibility and control over the rollout of software features (e.g., separating source code deployment from feature release) and enables debugging operations to be conducted with minimal impact on the user experience. Indeed, bypassing the redeployment of multiple web applications during flag updates significantly reduces time, cost and the potential for error. Additionally, maintaining the feature flags in a centralized source eliminates any need for the relevant code to be stored in the configuration of each application.

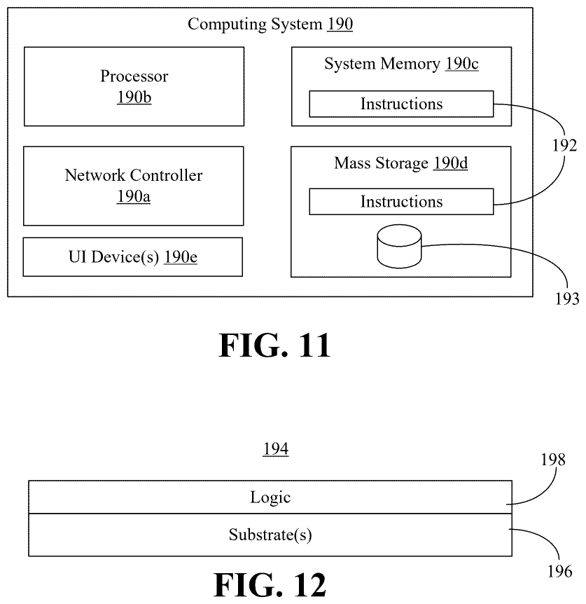

FIG. 11 shows a computing system 190 (190a-190e, e.g., server) that includes a network controller 190a (e.g., wired, wireless), a processor 190b (e.g., host processor, central processing unit/CPU), a volatile memory 190c (e.g., system memory, DRAM), mass storage 190d (e.g., storage device, flash memory, optical disc, hard disk drive/HDD, solid state drive/SDD) and one or more UI devices 190e (e.g., monitor, keyboard, mouse, speaker). In the illustrated example, the processor 190b executes instructions 192 retrieved from the volatile memory 190c and/or the mass storage 190d to conduct one or more aspects of the computer-implemented method 160 (FIG. 10), already discussed. Thus, execution of the instructions 192 causes the processor 190b to identify a flag associated with a software feature in response to a retrieval request received via an API, wherein the software feature is shared by a plurality of web applications, and wherein the plurality of web applications are associated with a plurality of users. Execution of the instructions 192 also causes the processor 190b to conduct an update to the flag in response to an update request received via the API, wherein the update prevents a first subset of the plurality of users from accessing the software feature, and wherein the update permits a second subset of the plurality of users to access the software feature. Moreover, execution of the instructions 192 also causes the processor 190b to bypass a redeployment of the plurality of web applications during the update. In an embodiment, the flag is retrieved from a centralized source 193 (e.g., database) that is external to the plurality of web applications.

The computing system 190 is therefore considered performance-enhanced at least to the extent that selectively granting access to software features on a per user (e.g., customer, agent) basis via the flag updates provides greater flexibility, extensibility and control over the rollout of software features and enables debugging operations to be conducted with minimal impact on the user experience. Indeed, bypassing the redeployment of multiple web applications during flag updates significantly reduces time, cost and the potential for error. Additionally, maintaining the feature flags in a centralized source eliminates any need for the relevant code to be stored in the configuration of each application.

FIG. 12 shows a semiconductor apparatus 194 (e.g., chip, die, package). The illustrated apparatus 194 includes one or more substrates 196 (e.g., silicon, sapphire, gallium arsenide) and logic 198 (e.g., transistor array and other integrated circuit/IC components) coupled to the substrate(s) 196. In an embodiment, the logic 198 implements one or more aspects of the method 160 (FIG. 10), already discussed.

Thus, the logic 198 can identify a flag associated with a software feature in response to a retrieval request received via an API, wherein the software feature is shared by a plurality of web applications, and wherein the plurality of web applications are associated with a plurality of users. The logic 198 may also conduct an update to the flag in response to an update request received via the API, wherein the update prevents a first subset of the plurality of users from accessing the software feature, and wherein the update permits a second subset of the plurality of users to access the software feature. Moreover, the logic 198 bypasses a redeployment of the plurality of web applications during the update.

The logic 198 may be implemented at least partly in configurable or fixed-functionality hardware. In one example, the logic 198 includes transistor channel regions that are positioned (e.g., embedded) within the substrate(s) 196. Thus, the interface between the logic 198 and the substrate(s) 196 may not be an abrupt junction. The logic 198 may also be considered to include an epitaxial layer that is grown on an initial wafer of the substrate(s) 196.

Thus, the technology described herein can control the features in applications and can be made accessible or inaccessible to specific users/customers or agent real time. The technology is also not required to maintain the flag in multiple applications. Rather, management of these flags is centralized. Moreover, status changes to feature flags are effective real-time without any redeployment for consuming applications. In addition, the technology described herein supports allowlisting of specific customers/users/agents or any of the data elements as per the business needs. Features can also be made active/inactive based on various conditions, tied to start and/or end date time, and so forth.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computing system comprising:
a network controller;
a processor coupled to the network controller; and
a memory coupled to the processor, wherein the memory includes a plurality of instructions, which when executed by the processor, cause the processor to:
identify a flag associated with a software feature in response to a retrieval request received via an application programming interface (API), wherein the software feature is shared by a plurality of web applications, and wherein the plurality of web applications are associated with a plurality of users,
conduct an update to the flag in response to an update request received via the API, wherein the update prevents a first subset of the plurality of users from accessing the software feature, and wherein the update permits a second subset of the plurality of users to access the software feature, and
bypass a redeployment of the plurality of web applications during the update.

2. The computing system of claim 1, wherein the plurality of instructions, when executed, further cause the processor to retrieve the flag from a centralized source that is external to the plurality of web applications.

3. The computing system of claim 1, wherein the update modifies an allowlist associated with the flag.

4. The computing system of claim 1, wherein the update modifies an activation date range associated with the flag.

5. The computing system of claim 1, wherein the plurality of instructions, when executed, further cause the processor to:
create the flag in response to a creation request received via the API;
activate the flag in response to an activation request received via the API; and
deactivate the flag in response to a deactivation request received via the API.

6. At least one computer readable storage medium comprising a plurality of instructions, which when executed by a computing system, cause the computing system to:
identify a flag associated with a software feature in response to a retrieval request received via an application programming interface (API), wherein the software feature is shared by a plurality of web applications, and wherein the plurality of web applications are associated with a plurality of users;
conduct an update to the flag in response to an update request received via the API, wherein the update prevents a first subset of the plurality of users from accessing the software feature, and wherein the update permits a second subset of the plurality of users to access the software feature; and
bypass a redeployment of the plurality of web applications during the update.

7. The at least one computer storage medium of claim 6, wherein the plurality of instructions, when executed, further cause the computing system to retrieve the flag from a centralized source that is external to the plurality of web applications.

8. The at least one computer storage medium of claim 6, wherein the update modifies an allowlist associated with the flag.

9. The at least one computer storage medium of claim 6, wherein the update modifies an activation date range associated with the flag.

10. The at least one computer storage medium of claim 6, wherein the plurality of instructions, when executed, further cause the computing system to create the flag in response to a creation request received via the API.

11. The at least one computer storage medium of claim 6, wherein the plurality of instructions, when executed, further cause the computing system to activate the flag in response to an activation request received via the API.

12. The at least one computer storage medium of claim 6, wherein the plurality of instructions, when executed, further cause the computing system to deactivate the flag in response to a deactivation request received via the API.

13. A semiconductor apparatus comprising:
one or more substrates; and
logic coupled to the one or more substrates, wherein the logic is implemented at least partly in one or more of configurable or fixed-functionality hardware, the logic to:
identify a flag associated with a software feature in response to a retrieval request received via an application programming interface (API), wherein the software feature is shared by a plurality of web applications, and wherein the plurality of web applications are associated with a plurality of users;
conduct an update to the flag in response to an update request received via the API, wherein the update prevents a first subset of the plurality of users from accessing the software feature, and wherein the update permits a second subset of the plurality of users to access the software feature; and
bypass a redeployment of the plurality of web applications during the update.

14. The semiconductor apparatus of claim 13, wherein the logic is further to retrieve the flag from a centralized source that is external to the plurality of web applications.

15. The semiconductor apparatus of claim 13, wherein the update modifies an allowlist associated with the flag.

16. The semiconductor apparatus of claim 13, wherein the update modifies an activation date range associated with the flag.

17. The semiconductor apparatus of claim 13, wherein the logic is further to create the flag in response to a creation request received via the API.

18. The semiconductor apparatus of claim 13, wherein the logic is further to activate the flag in response to an activation request received via the API.

19. The semiconductor apparatus of claim 13, wherein the logic is further to deactivate the flag in response to a deactivation request received via the API.

20. The semiconductor apparatus of claim 13, wherein the logic coupled to the one or more substrates includes transistor regions that are positioned within the one or more substrates.
